(19) United States
(12) Patent Application Publication
(10) Pub. No.: US 2014/0111029 A1
(43) Pub. Date: Apr. 24, 2014

(54) CONTROL FOR INTERMITTENTLY LOADED ELECTRIC APPLIANCE

(71) Applicant: LEAN-GREEN, LLC, Malvern, PA (US)

(72) Inventors: Christopher Robert Gutteridge, Wayne, PA (US); Michael David Stephen Harria, Paoli, PA (US)

(73) Assignee: LEAN-GREEN, LLC, Malvern, PA (US)

(21) Appl. No.: 13/659,110

(22) Filed: Oct. 24, 2012

(51) Int. Cl. H01H 47/00

(52) U.S. Cl. 307/126

(57) ABSTRACT

A control for reducing energy consumption by an intermittently loaded, electric motor-driven appliance automatically “learns” the idling current of an appliance, establishes a threshold current greater than the idling current, and switches off the appliance at the end of a time interval following a sequence of operation in which the appliance is operated under load and then operated at idle.

### FIELD OF THE INVENTION

This invention relates generally to controls for electric motors, and more particularly to a current-sensing control for automatically shutting down an intermittently loaded electric motor when it has been running at or near idle for an extended interval, indicating an unloaded condition.

### BACKGROUND OF THE INVENTION

Various kinds of industrial machines are operated by an electric motor that is subject to intermittent load, but nonetheless operated continuously. Such machines are frequently operated continuously because it is inconvenient to turn the motor off when it is not needed, because the sudden application of a high load to a motor before it reaches operating speed can result in a stalling of the motor and damage to the machinery, or because an attempt to start the motor when it is already heavily loaded can similarly result in damage.

An example of an intermittently loaded machine is an industrial plastics grinding machine of the kind used in recycling. Such machines are typically operated by an electric motor. Material to be ground is typically fed into an intake hopper by a conveyor that is loaded manually. In such a case, the timing and rate of feed are dependent on one or more human operators, and are unpredictable. Determining when grinding of a batch of material is complete is also sometimes difficult, and premature switching off of the motor can result in jamming of the grinding apparatus, requiring a laborious and time-consuming clearing operation. Therefore, instead of turning the motor off when it is not needed, operators find it more convenient to run the motor continuously to be certain that it is always operating at full speed when material arrives at the intake hopper, and to assure completion of the grinding of each batch of material.

The motors in plastics grinding machines, and in similar intermittently loaded industrial machines have horsepower ratings typically in the range from less than 20 to over 100 HP under load. Even when unloaded, the power factor in such motors is such that they can draw many hundreds and even thousands of watts of power. Therefore, if a grinder is operated at idle for an extended interval of time, a significant amount of energy can be wasted.

### SUMMARY OF THE INVENTION

This invention addresses the problem of energy waste by providing a control which can “learn” the idling current of an appliance either though manually entered input or automatically, establish a threshold current greater than the idling current, and switch off the appliance at the end of a time interval following a sequence of operation in which the appliance is operated under load and then operated at idle.

More particularly, in accordance with the invention, a control for an intermittently loaded electric appliance comprises an electrically controlled switch, a current sensor, and a microcontroller. The electrically controlled switch is connectible to a conductor arranged to deliver operating power to the appliance, and openable in response to a control signal to interrupt the delivery of operating power to the appliance. The current sensor samples the current drawn by the appliance, and provides a signal representative of the load on the appliance. The microcontroller is responsive to the signal provided by the current sensor and is programmed to determine when the current drawn by the appliance has fallen below a threshold current level greater than the level of an idling current drawn by the appliance after the appliance is turned on and before the appliance is under an operating load, but less than the level of the current drawn by the appliance when under the operating load. The microcontroller is also programmed to deliver a control signal to the electrically controlled switch to open the switch after a delay interval following the time when the current drawn by the appliance falls below the threshold current level and during which the current drawn by the appliance remains below the threshold current level. Energy consumption by the appliance is reduced by removal of operating power when the appliance is unloaded for an extended time.

The microcontroller can also be programmed to determine the level of the idling current and establish the threshold current level. The microcontroller can determine the idling current level and establish the threshold current by monitoring motor current over a continuous short interval. Alternatively, it can be programmed to establish the threshold current level on the basis of a series of cycles during which the appliance is operated alternately under load and at idle.

The current sensor can be a transformer having primary and secondary conductors, the primary being connectible in series with a conductor arranged to deliver operating power to the appliance.

The control can include means such as a manually operable variable resistor for adjusting the relationship between the threshold current level and the idling current. The ratio of the threshold current level to the idling current is preferably in the range from 1.15:1 to 2:1.

Means, such as a manually operable variable resistor can also be provided for adjusting the delay interval.

Another aspect of the invention is an electric motor-operated appliance having a control including the electrically operated switch and current sensor as described above, and a microcontroller for determining when the current drawn by the motor has fallen below a threshold current level greater than the level of an idling current drawn by the motor after the motor is turned on and before the motor is under an operating load, but less than the level of the current drawn by the motor when under the operating load. The microcontroller is also programmed to deliver a control signal to the electrically controlled switch. The motor operated appliance can include one or more of the subsidiary features mentioned above.

Still another aspect of the invention is a method for controlling an intermittently loaded electric appliance by utilizing features of the control as described above.

### BRIEF DESCRIPTION OF THE DRAWINGS

FIG. 1 is a schematic diagram showing the control of the invention incorporated into a motor-operated appliance;

FIG. 2 is a plot of motor current over time, illustrating the operation of the control;

FIG. 3 is block diagram showing more details of the control; and

FIGS. 4A and 4B constitute a two-part flow diagram illustrating the operation of the control.

### DETAILED DESCRIPTION OF THE PREFERRED EMBODIMENTS

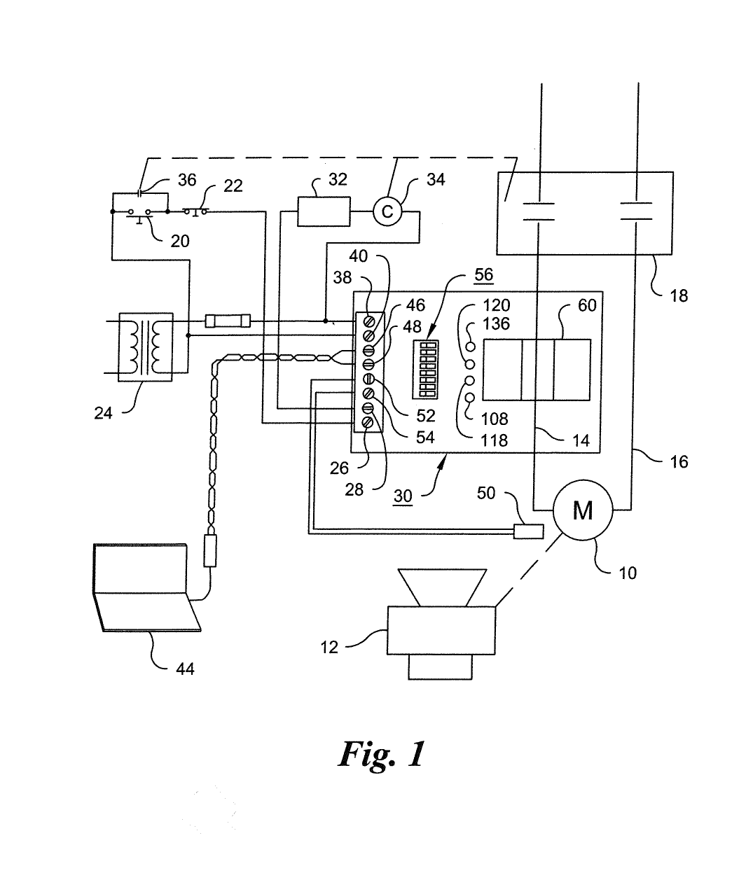

In FIG. 1, motor 10 is a large AC induction motor arranged to operate a plastics grinding machine 12. The motor can be a single phase or multi-phase motor. For the purpose of illustration, the motor is supplied by single phase alternating current through a pair of conductors 14 and 16. Internal phase shift components (not shown) are used to provide the phase shift required to start the motor. Conductors 14 and 16 are supplied from AC mains through contactor 18, which can be closed by momentary depression of a start button 20 and opened by momentary depression of a stop button 22, the start and stop buttons being connected in series.

A low voltage is supplied by transformer 24 through the start and stop buttons, terminals 26 and 28 on a control 30, and safety interlocks 32, to a contactor electromagnet coil 34. Safety interlocks can be provided to disable the machinery when an access door is open, or when some other potentially dangerous condition exists. The contactor electromagnet also operates holding contacts 36 in shunt with the start button 20.

The transformer 24 not only supplies operating current for the contactor coil, but also supplies operating current for the control 30 through terminals 38 and 40.

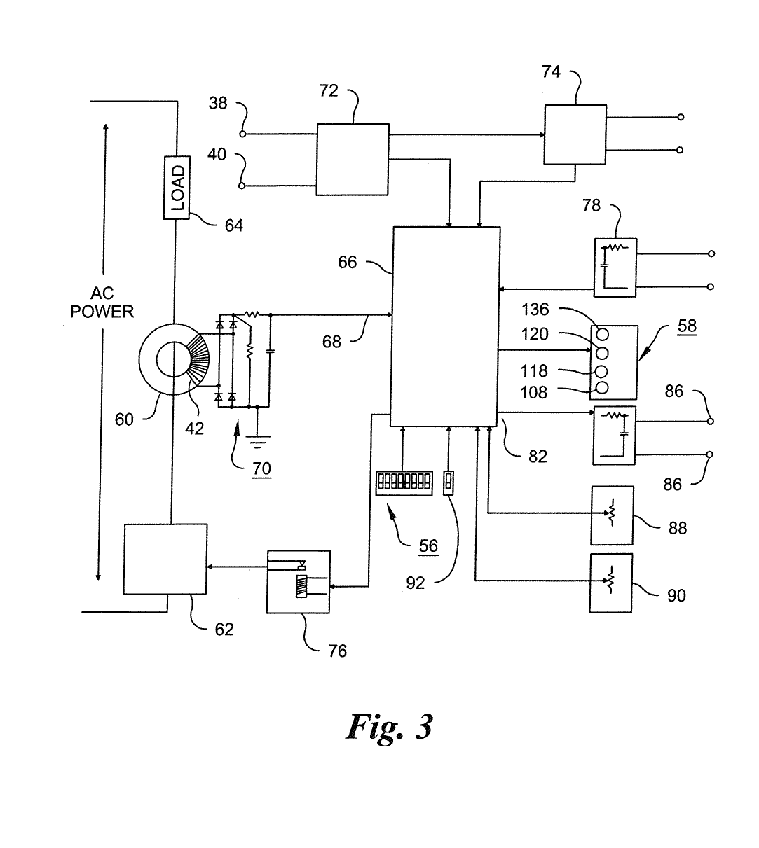

As shown in FIG. 1, a toroidal core 60 on the control 30 surrounds conductor 14 so that conductor 14 serves as the primary of a transformer. A coil 42 (not shown in FIG. 1 but shown in FIG. 3), wound onto core 60, serves as the secondary of the transformer.

As will be described, the control determines, on the basis of the current sensed by the coil 42, when to break the circuit to the contactor coil 34 by opening internal relay contacts within the control 30 that connect control terminals 26 and 28. The motor current can be monitored by an operator though a computer terminal 44 connected to terminals 46 and 48 of the control 30. In a simpler alternative embodiment, motor current can be monitored by a meter connected to the control 30.

A vibration sensing transducer 50 affixed to the motor 10 or to another component of machine 12 delivers a signal representing the magnitude of vibration of the machine to terminals 52 and 54 of the control. A set of switches 56 is provided on the control for setting the communications addresses for the microcontroller and for setting the baud rate for communication between the microcontroller and an external computer. A set of status indicator lights 58 is also provided on the control.

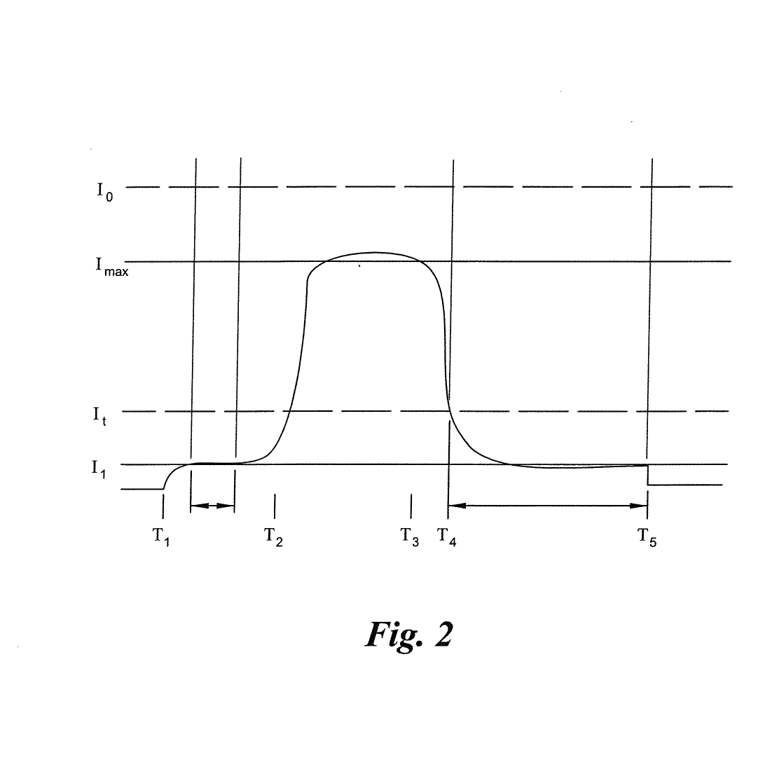

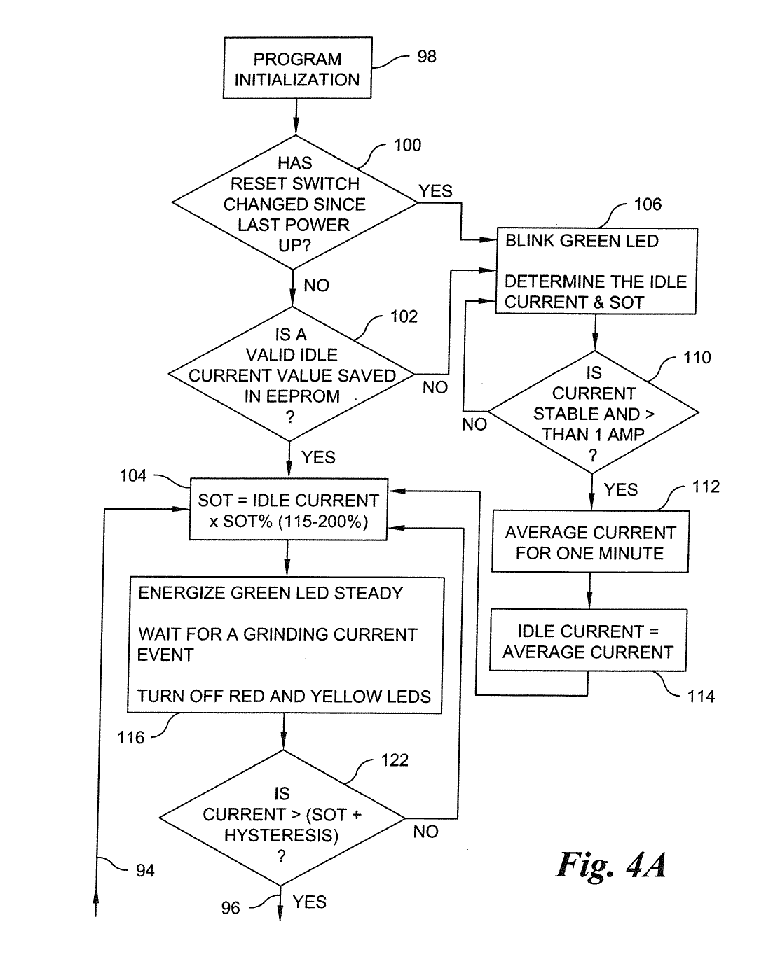

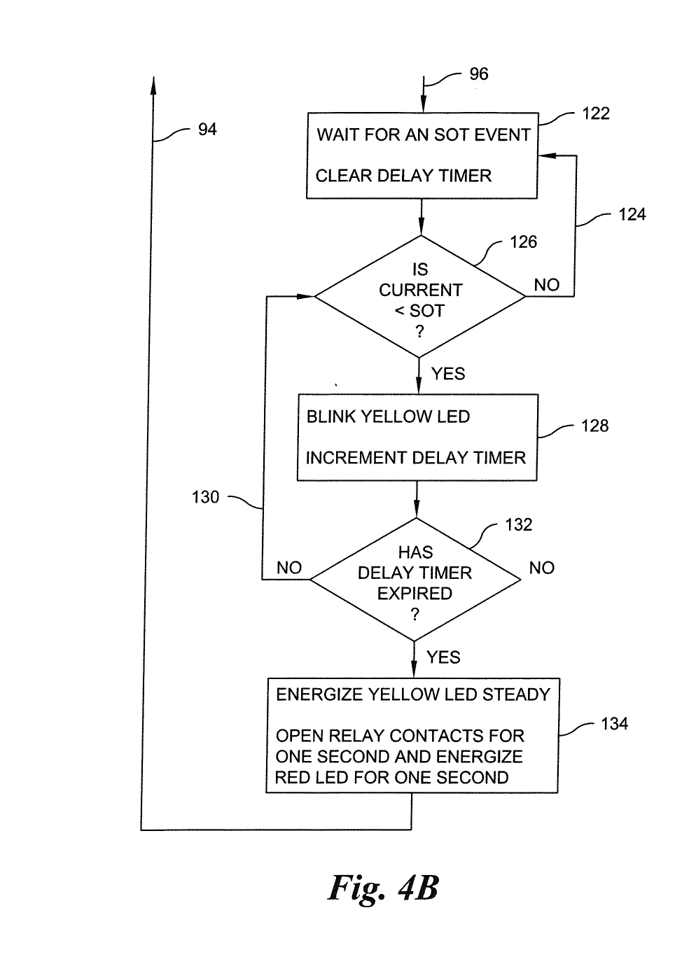

The detailed operation of the control, which will be explained with reference to FIGS. 3, 4A and 4B will be better understood if reference is also made to the plot in FIG. 2, which shows how the current in motor 10 varies depending on the mechanical load applied to the motor.

When the contactor 18 (FIG. 1) is open, the motor current is zero as shown in FIG. 2. When the start button is depressed momentarily, the coil 34 is energized, the contactor closes, and the motor starts. The holding contacts 36 also close, maintaining a path for current from transformer 24 to the contactor coil 34. Therefore, the contactor coil remains energized unless at least one of three events takes place: the stop push button 22 is operated, the safety interlocks 32 are tripped, or the control opens the internal path between its terminals 26 and 28.

The motor of a plastics grinding machine is under a heavy load only when material to be ground is being fed to the machine. The plot in FIG. 2 shows that, immediately following the depression of the start button at time T₁, the motor begins to operate and the motor current rises quickly to an idle current level I₁, where it remains until feeding of material to the hopper of the grinder is commenced at time T₂. At that time, the motor is brought under load, and the current rises rapidly to a grinding current level Iₘₐₓ. The current remains at or near Iₘₐₓ until the feed of material to the grinding machine is interrupted or discontinued at time T₃.

In the meanwhile, the control determines a threshold current level Iₜ, which is greater than the idling current I₁, but lower than the grinding current Iₘₐₓ. As will be explained, the threshold current Iₜ can be determined in various ways. In the case illustrated, the threshold current is based solely on the idle current I₁, and is equal to the idle current multiplied by a predetermined factor, for example, 1.15, which takes into account line voltage variations and other conditions which, if they occur during the delay interval, could prevent automatic shutdown of the motor at the end of the delay interval.

As shown in FIG. 2, the motor current falls below the threshold current I₁ at time T₄. When the motor current falls below the threshold current, the predetermined delay interval is commenced. If the motor current remains below the threshold value throughout the delay interval, the control opens the contactor by opening the internal current path from terminal 26 to terminal 28 (FIG. 1) at time T₅.

An overload threshold current level Iₒ is also set in the control so that the control can automatically open the contactor in the event that the machinery is jammed or some other condition occurs that places the motor under excessive load.

In FIG. 3, which shows further details of the control, the current sensing coil 42 is shown wound on the toroidal core 60 through which conductor 14 extends. The start-stop circuits, including the start and stop push buttons, the safety interlocks, the contactor the holding contacts and the contactor coil are included in the stop/start circuit block 62. Load 64 can be the motor or any other electrical load to be controlled.

At the heart of the control is a microcontroller 66, which can be any of various available microcontrollers. Microcontroller PIC16F88, available from Microchip Technology Inc. in Chandler, Ariz., USA, is an example of a suitable microcontroller. The microcontroller chip includes an analog-to-digital converter having an input 68 that receives a DC representation of the motor current derived from the coil 42 through a circuit 70 that includes a bridge rectifier, a burden resistor, and an R/C filter having a time constant, such as 500 mS, suitable to remove line current noise present on conductor 14.

A power supply 72 is connected to the secondary of transformer 24 (FIG. 1) at terminals 38 and 40 (also shown in FIG. 1). The power supply 72 delivers a regulated, low, DC voltage from an intermediate AC voltage supplied by transformer 24. For example, transformer 24 is preferably designed to deliver 24 VAC to operate the contactor coil, and power supply 72 is designed to utilize the 24 VAC supply and deliver 5 VDC for operation of the control.

An interface 74, preferably an RS-485 transceiver, for providing communication between the microcontroller 66 and terminal 44 (FIG. 1), is powered by 5VDC from power supply 72. The microcontroller is also powered by 5 VDC from power supply 72. The power for the communications interface 74 is galvanically isolated from the power for the microcontroller by a switch mode DC to DC converter in the power supply in order to prevent ground loop problems. For signal isolation, optical coupling is used in the “receive” output and in the “transmit” input of the communication interface.

The communication interface can be used to set the operating parameters of the microcontroller from a computer terminal (i.e., terminal 44 in FIG. 1)

The microcontroller is arranged to operate a relay 76 in the controller. The relay contacts, which are normally closed, are connected to terminals 26 and 28 (FIG. 1) and, when opened, open the circuit that includes the start and stop buttons, the safety interlocks and the contactor coil. A mechanical relay is preferred for this purpose over solid state switching devices for its ability to open the circuit reliably. Where the motor is controlled by an alternative start-stop device such as a programmed logic controller (PLC), a normally open relay or a solid state switching device can be used instead of the normally closed relay.

The output of the vibration sensor 50 (FIG. 1) is delivered to an analog to digital converter in microcontroller 66 through an RC filter 78, provided to remove electrical noise. The vibration sensor output can be used to turn off the motor when the magnitude of vibration of the machine exceeds a preset level. In a more advanced version of the control, an algorithm can be employed to enable the microcontroller to analyze trends in vibrations to detect degradation and predict failures of the machinery.

Status indicator LEDs 58 (also shown in FIG. 1) are operated by the microcontroller, and are provided to show the current status of a detection sequence being carried out by the microcontroller as will be explained below, and also to show the communication interface activity.

The microcontroller delivers a pulse width modulated series of pulses the duty cycle of which is proportional to the motor current. These pulses are delivered through an output 82 to an RC filter 84 having terminals 86 to which a voltmeter (not shown) can be connected to monitor the motor current. The filter averages the pulses, delivering a voltage that is proportional to the motor current. As an example, an analog voltage level in the range from 0 to 5V can be produced that is directly proportional to the motor current in a range from 0 to 100 A.

The delay from time T₄ to time T₅ (FIG. 2) can be adjusted through a user-operated variable resistor 88 connected to the microcontroller, and the current threshold level Iₜ (FIG. 2) can be adjusted through a user-operated variable resistor 90 also connected to the microcontroller.

Switches 56 on the controller are used to set the communications parameters, i.e., the baud rate and the unit address, and a resetting switch 92 is provided for resetting the control when the communication interface is not being used.

The flow diagram in FIGS. 4A and 4B illustrates the operation of the control in a typical embodiment of the invention. Path 94 in FIG. 4A is continuous with path 94 in FIG. 4B and path 96 in FIG. 4A is continuous with path 96 in FIG. 4B. Thus, the figures together constitute a single flow diagram.

Initialization of the program in microcontroller 66 (FIG. 3) takes place on powering up of the control. Following initialization in step 98, in decision block 100 a determination is made whether the reset switch 92 (FIG. 3) has been operated. If it has, then it is necessary to establish a new switch-off threshold (SOT) current level Iₜ. If the reset switch has not been operated, then the microcontroller determines in block 102 whether a valid idle current value has been saved. If a valid idle current has been saved, the switch off threshold is set in block 104 at a value in the range from 115% to 200% of the idle current.

If the reset switch has been operated, i.e., if the decision at block 100 is “yes,” the program proceeds to block 106, and causes a green indicator LED 108 (FIGS. 1 and 3) to blink while determining the idle current and the switch-off threshold (SOT). If the microcontroller determines that the current is stable and greater than 1 A in block 110, it determines the average over an interval, e.g. one minute, in block 112 and sets the idle current to correspond with the average in block 114. If the current is either unstable or falls below 1 A, the process is continued by return to block 106.

When the idle current is determined, the switch off threshold (SOT) is set in block 104. This threshold will ordinarily be in the range from 1.15 to 2 times the averaged idle current.

When the switch off threshold is established the green light 108 (FIGS. 1 and 3) stops flashing and is illuminated continuously, as indicated in block 116. The control then turns off a yellow timing indicator LED 118 and a red relay indicator LED 120 (FIGS. 1 and 3), and, as indicated in blocks 116 and 122, waits for the motor current to increase to a level above the threshold level Iₜ (FIG. 2) by a preset amount allowing for hysteresis.

The microcontroller then proceeds to block 122, where it ensures that the delay timer is cleared (set to the start of a delay interval) and waits for the motor current to fall below the switch off threshold (SOT).

As long as the motor current is at least at the threshold (i.e., the motor current is greater than or equal to the SOT), the delay timer remains cleared as indicate by path 124 from decision block 126 to block 122. However, if the motor current falls below the threshold (at T₄ in FIG. 2), the delay timer starts and the yellow timing indicator light 118 begins to blink as indicated in block 128.

If, during the delay interval, which as indicated previously, can be adjusted by adjustment 88 (FIG. 3), the motor current rises to a level above the threshold current Iₜ, the controller follows paths 130 and 124 from block 132 and the delay is reset to zero by clearing the delay timer in block 122. However, if the delay expires without the motor current rising above the threshold level, the controller proceeds to block 134, the yellow timing indicator LED 118 becomes steadily illuminated, and the contracts of relay 76 (FIG. 3) open for a short time, e.g., one second, removing current from the holding circuit that maintains the contactor coil 34 (FIG. 1) energized. The result is that the contactor opens, shutting down the motor. At the same time, as indicated in block 134 in FIG. 4B, the red relay indicator LED 120 is turned on for a short time. The relay indicator can be turned on for a duration corresponding to the duration of relay opening, and in that case, the relay indicator can be used to facilitate troubleshooting. However, the relay indicator duration can be longer, and independent of the relay opening time. In either case, the red LED indicates that the relay has opened. When the motor is shut down, the controller returns, following path 94, to the state in which the idle current is set at block 104 and the system waits for the motor current to fall below the threshold once more.

As will be apparent, vibration sensing, and the overload protection that can be built into the microcontroller, are optional features that can be easily included in the control. The communications feature is also optional, but when used, allows for setting of various parameters in the microcontroller from an external terminal, and for collection of data concerning the operation of the control over an extended time, including data on power consumption, energy saving, real time motor current, counting of starts and stops of the motor, total on time, total off time, and system status. The communication interface can also be used to collect vibration data if a vibration sensor is used. A communications status-indicating LED 136 (FIGS. 1 and 3) is provided to show when communication is taking place between the microcontroller and an external computer terminal.

The control described above is one example of a number of possible embodiments of the invention. Various modifications can be made to the control. For example, whereas the shut off threshold current can be established on the basis of the measured idling current by multiplying the idling current by a suitable factor, usually in the range from 1.15 to 2, the shut off threshold can be established by adding a predetermined amount of current to the idling current. As a further alternative, the shut off threshold current can be established by taking into account not only the idling current but also the current drawn by the motor while under load. That is, the threshold can be set so that it exceeds the idle current by an amount equal to a predetermined percentage of the current drawn by the motor under load.

As another alternative, the apparatus can be operated over a number of calibration cycles during which data on the idle current and the loaded motor current are accumulated and taken into account to establish a shut off threshold current level. By gathering data over a number of calibration cycles, the risk of a false shutdown during loaded operation of the motor can be reduced.

As still another alternative, the shut off threshold current can be established by a calibration procedure in which the motor is run at idle for a period of time to determine a minimum idling current, then a calibration load corresponding the smallest load likely to be imposed on the motor is added. In the case of a plastics grinder, the smallest likely load can be applied by inserting a specific kind and quantity of plastics into the grinder. If the control is used to shut down a conveyor motor, material corresponding to the smallest expected load can be placed on the conveyor. The microcontroller can be caused to set a shutoff threshold current at an intermediate level between the current drawn when the motor is loaded by the calibration load and the idle current, e.g. a mean value between the lightly loaded current and the idle current. As a further alternative, after determining the idle current and the lightly loaded current, a user can raise a manual threshold setting to a point at which the motor is shut down as a result of the calibration load, and then adjust the threshold downward to ensure that the control will not shut off the motor when the load is at least as great as the calibration load.

Although the invention has been described in the context of a plastics grinding apparatus, the invention has potential utility for reducing energy usage by conveyors, and other appliances that are subject to intermittent loads.

What is claimed is:

1. A control for an intermittently loaded electric appliance comprising:
an electrically controlled switch connectible to a conductor arranged to deliver operating power to the appliance, and openable in response to a control signal to interrupt the delivery of operating power to the appliance;
a current sensor for sampling the current drawn by the appliance, and providing a signal representative of the load on the appliance; and
a microcontroller responsive to said signal and programmed to:
(a) determine when the current drawn by the appliance has fallen below a threshold current level greater than the level of an idling current drawn by the appliance after the appliance is turned on and before the appliance is under an operating load, but less than the level of the current drawn by the appliance when under said operating load; and
(b) deliver a control signal to said electrically controlled switch to open said switch after a delay interval following the time when the current drawn by the appliance falls below said threshold current level and during which the current drawn by the appliance remains below the threshold current level;
whereby energy consumption by the appliance is reduced by removal of operating power when the appliance is unloaded for an extended time.

2. The control according to claim 1, in which said microcontroller is also programmed to determine the level of the idling current and establish said threshold current level.

3. The control according to claim 1, in which said current sensor is a transformer having primary and secondary conductors, the primary being connectible in series with a conductor arranged to deliver operating power to the appliance.

4. The control according to claim 1, including means for adjusting the relationship between the threshold current level and the idling current.

5. The control according to claim 1, in which the ratio of the threshold current level to the idling current is a ratio in the range from 1.15:1 to 2:1.

6. The control according to claim 1, including means for adjusting the ratio of the threshold current level to the idling current through a range from 1.15:1 to 2:1.

7. The control according to claim 1, including means for adjusting said delay interval.

8. The control according to claim 1, in which the microcontroller programmed to establish said threshold current level on the basis of a series of cycles during which the appliance is operated alternately under load and at idle.

9. An electric appliance comprising:
an electric motor:
an electrically controlled switch connected in series with a conductor arranged to deliver operating power to the motor, and openable in response to a control signal to interrupt the delivery of operating power to the motor;
a current sensor arranged to sample the current drawn by the motor, and providing a signal representative of the load on the motor; and
a microcontroller responsive to said signal and programmed to:
(a) determine when the current drawn by the motor has fallen below a threshold current level greater than the level of an idling current drawn by the motor after the motor is turned on but before the motor is under an operating load but less than the level of the current drawn by the motor when under said operating load; and
(b) deliver a control signal to said electrically controlled switch to open said switch after a delay interval following the time when the current drawn by the appliance falls below said threshold current level and during which the current drawn by the motor remains below the threshold current level;
whereby energy consumption by the motor is reduced by removal of operating power when the motor is unloaded for an extended time.

10. The control according to claim 9, in which said microcontroller is also programmed to determine the level of the idling current and establish said threshold current level.

11. The electric appliance according to claim 9, in which said current sensor is a transformer having primary and secondary conductors, the primary being connected in series with a conductor arranged to deliver operating power to the motor.

12. The electric appliance according to claim 9, including means for adjusting the relationship between the threshold current level and the idling current.

13. The electric appliance according to claim 9, in which the ratio of the threshold current level to the idling current is a ratio in the range from 1.15:1 to 2:1.

14. The electric appliance according to claim 9, including means for adjusting the ratio of the threshold current level to the idling current through a range from 1.15:1 to 2:1.

15. The electric appliance according to claim 9, including means for adjusting said delay interval.

16. The electric appliance according to claim 9, in which the microcontroller programmed to establish said threshold current level on the basis of a series of cycles during which the appliance is operated alternately under load and at idle.

17. The electric appliance according to claim 9 including a vibration sensor arranged to respond to vibration of said appliance, and in which the microcontroller is responsive to the vibration sensor to deliver a signal to said electrically controlled switch to open said switch when the vibration sensor detects vibration at a magnitude exceeding a predetermine magnitude.

18. A method for controlling an intermittently loaded electric appliance comprising:
measuring the level of the idling current drawn by the appliance after the appliance is turned on but before the appliance is placed under an operating load;
measuring the level of the current drawn by the appliance when under said operating load;
establishing a threshold current level greater than the level of said idling current but less than the level of the current drawn by the appliance when under load;
using a microcontroller, determining when the current drawn by the appliance has fallen below the said threshold current level after having reached a level of the current drawn by the appliance when under said operating load; and
delivering from said microcontroller a control signal to an electrically controlled switch in series with a conductor arranged to deliver operating power to said appliance, to open said switch after a delay interval following the time when the current drawn by the appliance falls below said threshold current level and during which the current drawn by the appliance remains below the threshold current level;
whereby energy consumption by the appliance is reduced by removal of operating power when the appliance is unloaded for an extended time.
